(19) United States
(12) Patent Application Publication
(10) Pub. No.: US 2005/0214165 A1
(43) Pub. Date: Sep. 29, 2005

(54) Device for analyzing a test sample and for providing corresponding analysis data

(75) Inventors: Wolfgang Babel, Weil der stadt (DE); Dirk Steinmuller, Karlsruhe (DE)

Correspondence Address: BACON & THOMAS, PLLC, 625 SLATERS LANE, FOURTH FLOOR, ALEXANDRIA, VA, 22314, US

(73) Assignee: Endress + Hauser Conducta GmbH + Co. KG, Gerlingen (DE)

(21) Appl. No.: 10/513,469

(22) PCT Filed: May 7, 2003
(86) PCT No.: PCT/EP03/04734

§ 371 Date: Jun. 2, 2005

(30) Foreign Application Priority Data
May 8, 2002 (DE) 102 20 829.8

(51) Int. Cl. G01N 35/00

(52) U.S. Cl. 422/63; 422/68.1

(57) ABSTRACT

A device for the analysis of a test sample includes the following exchangeable modules: At least one function module, which is embodied such that it provides measurement signals, which represent at least one physical or chemical process parameter; at least one pump module, which is embodied such that it supplies the function module in predeterminable cycles, depending on the particular function module being used, with a predeterminable amount of sample and/or a predeterminable amount of at least one reagent or a predeterminable amount of a cleaning agent; an electronics module, which controls the working cycles of the particular pump module being used and/or of the particular function module being used, which evaluates the measurement signals delivered by the function module, and which provides the corresponding analysis data of the test sample.

The invention relates to a device for analyzing a test sample and for the providing of corresponding analysis data.

So-called on-line analyzers are marketed by the assignee under the trademark STAMOLYS. The analyzers are used in the monitoring and optimizing of the cleaning performance of a clarification plant, in the monitoring of aeration tanks and clarification plant effluent or in the control of filler dosing. Examples of parameters measured and monitored include the concentrations of ammonium, phosphate or nitrate in a test sample. The analysis of a test sample occurs on the basis of known measuring methods that do not need to be considered in greater detail here.

On-line analyzers register daily information preferably continuously as a function of time. They deliver, on the one hand, reliably the desired information with respect to the developing operation of the plant; on the other hand, information respecting possibly required changes in the process technology are furnished. On the basis of the analysis data, sometimes quite considerable savings in operating means and operating costs are achieved.

The working procedure in an on-line analyzer containing a calorimetric measuring device is roughly as follows: a pump fills the permeate—thus, the collected test sample—into a mixing container. A reagents pump feeds to the test sample a suitable reagent in a specified mixing ratio. The reagent reacts with the test sample, whereby the test sample turns color in a characteristic manner. A measurement of the extinction or the absorption of radiation directed through the reacted test sample is determined by means of a photometer or a spectrometer. The extinction or the absorption delivers information on the concentration of a chemical element or a chemical compound in the test sample. Preferably, the temperature of the photometer is also controlled in the case of the STAMOLYS analyzer. In this way, the intended reaction between the permeate and the reagent can occur reproducibly and within a short time.

On-line analyzers must always be matched to the given application. Thus, widely varied pump systems and measuring devices come into use. Additionally, an on-line analyzer is usually designed for a certain number of measurement locations, from which the test samples are taken in a chronological sequence. As a result, also the control/evaluation unit, the so-called electronics part, must be matched to the particular pump and measuring systems being used. Consequently, the end result is a very large multiplicity of differently constructed analyzers. From the manufacturing point of view, the construction of known analyzers is very complicated and inflexible.

An object of the invention is to provide a cost-favorable and highly flexible, on-line analyzer.

The object is achieved by a device which includes the following exchangeable modules: at least one function module embodied such that it can provide measurement signals representing at least one physical or chemical, process parameter; at least one pump module, which is embodied such that it can, in specified cycles depending on the particular function module being used, supply a predeterminable amount of sample and/or a predeterminable amount of at least one reagent or a predeterminable amount of a cleanser into the function module; an electronics module, which guides the working cycles of the particular pump module being used and/or the particular function module being used, evaluates the measurement signals delivered by the function module, and makes the corresponding analysis data of the test sample available. According to the invention, the most varied of analyzers can be realized with a minimum number of different modules, by the changing and exchanging of individual modules matched to the individual, measured parameters and measurement methods.

Preferably, the electronics module itself also has a modular construction. It is essentially divided into three components:
a transmitter module for the different measurement methods (here one distinguishes e.g. a module for a calorimetric measurement method, a module for a spectrometric measurement method and a module for an ion-selective measurement method);
a processor module, which assumes the signal processing as a function of the given application;
a peripherals module, which e.g. actuates valves.

The goal of the modular construction of the control/evaluation electronics is, also in this case, a reduction in the multiplicity of components. The modular construction of the electronics is distinguished by a great flexibility in the manner of data display and in the manner of connection on the side of the customer. Preferably, the modules of the electronics unit can be plugged onto a carrier unit and simultaneously make contact. In similar manner, also the function and pump modules, etc. are secured simply and quickly to a carrier unit via a plug mechanism.

The function module is, for example, an ion-selective measurement device, or a calorimetric measuring device. The calorimetric measuring unit can be either a photometer or a spectrometer. Colorimetric measuring devices can determine, for example, the concentration of ammonium, nitrate or orthophosphate in a test sample.

In an advantageous further development of the analyzer of the invention, a device for preparing the test sample is integrated into the function module. This leads to a compact form of construction. Especially a mixer module is provided, in which the test sample and at least one reagent are mixed together in a predeterminable ratio.

An advantageous further development of the device of the invention provides a display module, on which, among other things, the analysis data or the calibration data are displayed. Preferably, the electronics module is additionally embodied such that it is usable for different display and/or input modules. In this way, a rationalization is, in turn, achieved respecting the subject of component multiplicity in the case of analyzers. For the display of measurement data, simple exchange of the front/display module enables implementation of various display sizes and colored presentations. For the connection on the side of the customer, exchange or installation of suitable modules makes it possible to effect targeted changes, and to accommodate customer wishes, respecting the number of test streams to be measured, the manner of forwarding of measured values, and the supply of power.

According to one embodiment of the device of the invention important for some applications, at least one of the following modules is additionally provided:
A duct switching module for switching between different process cycles;
a measurement location switching module for extracting a test sample out of at least two different measurement locations;
a staging module, with which a test quantity is extracted from the measurement location and in which the test quantity is stored before the analysis;
a refrigeration module for keeping reagent and/or test sample cool;
a digestion module for sample preparation.

It is especially advantageous in connection with the device of the present invention, when the modules are mounted exchangeably on a carrier unit. In such case, the various modules are preferably mounted at suitably provided places. The various modules of a category (function modules, pump modules, etc.) are approximately equal with respect to their dimensions and with respect to their manner of securement.

If the analyzer is situated in the open or at an unprotected place, then the carrier unit is preferably arranged in a housing. If the analyzer is set up at a protected place, then a cost-favorable variant of the device of the invention provides that the carrier unit is mounted on a frame. Preferably, the frame or the carrier unit is additionally embodied so that it can be folded out.

In an advantageous further development of the device of the invention, at least one receptacle is provided, in which the at least one reagent is stored. In order to assure a problemless transport, the receptacle for the reagent, or the cleaning agent, is arranged in an accommodating unit. If the accommodating unit is additionally to serve for catching escaping reagent or cleaning agent, then the accommodating unit is provided in the form of a collecting pan.

According to a preferred form of embodiment of the device of the invention, the electronics module and the remaining modules of the analyzer are separated from one another in a housing or arranged on a frame. In this way, the wet and dry parts can be purposely kept separated from one another. Especially to be avoided is that overflowing or escaping liquid comes in contact with the electronics part. Preferably, the electronics module is, moreover, arranged in the upper region of the housing or frame. Additionally, the electronic/electrical components in the functional area ‘analysis module’ are arranged separated from the non-electrical or non-electronic components by at least one dividing wall.

According to an advantageous further development of the device of the invention, an outlet is provided, via which a reacted test sample and/or a cleaning agent for the cleaning of the pump, function and mixer modules can be drained off. One variant provides that the outlet is located in a side wall of the housing and that reacted test sample and/or used cleaning agent are/is conducted over a connecting line to the outlet. Alternatively, an outlet pipe is provided, arranged in the lower region of the housing. In order to assure a safe discharge of the reacted test sample or cleaning agent, the cross sectional area of the outlet pipe is plural-times greater than the cross sectional area of the outlet opening of the function module.

In many instances of application, it is necessary that plural analyses must be conducted in parallel with one another. In this connection, a favorable embodiment of the device of the invention provides that plural, modularly constructed measuring devices are arranged as spatial neighbors of one another. Furthermore, a common electronics module is provided, via which the individual measurement devices are actuated and which makes the analysis data available to the individual measurement devices.

The invention will now be explained in greater detail on the basis of the following drawings, whose figures show as follows:

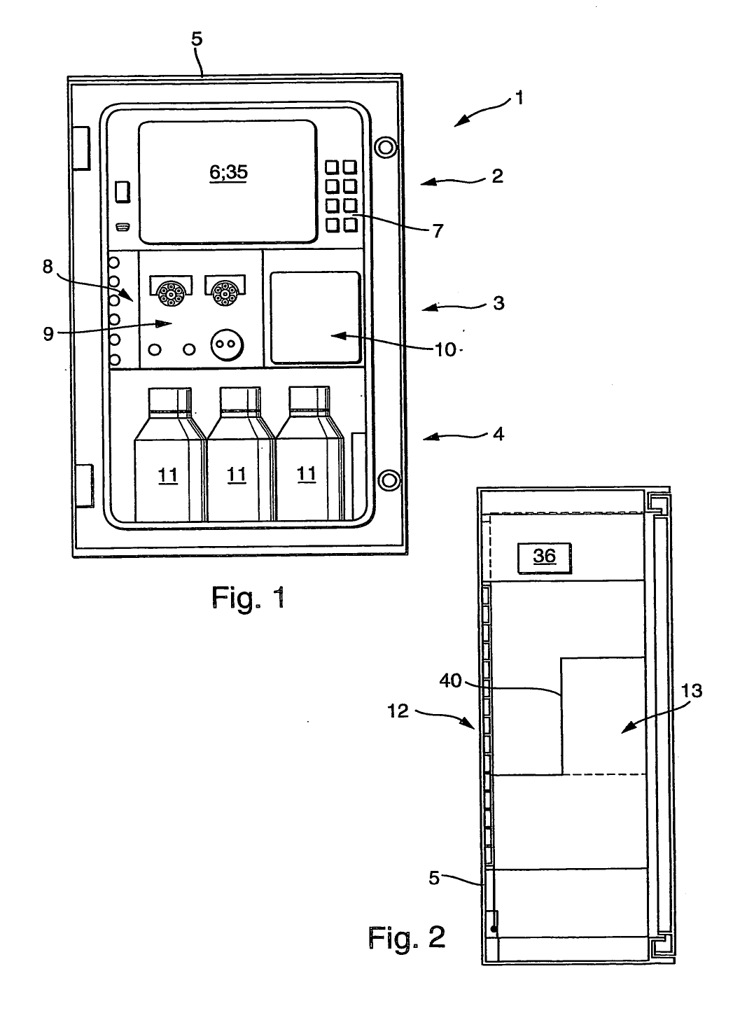

FIG. 1: A schematic presentation of an analyzer of the invention, in front view,

FIG. 2: a schematic presentation of an analyzer of the invention, in cross section,

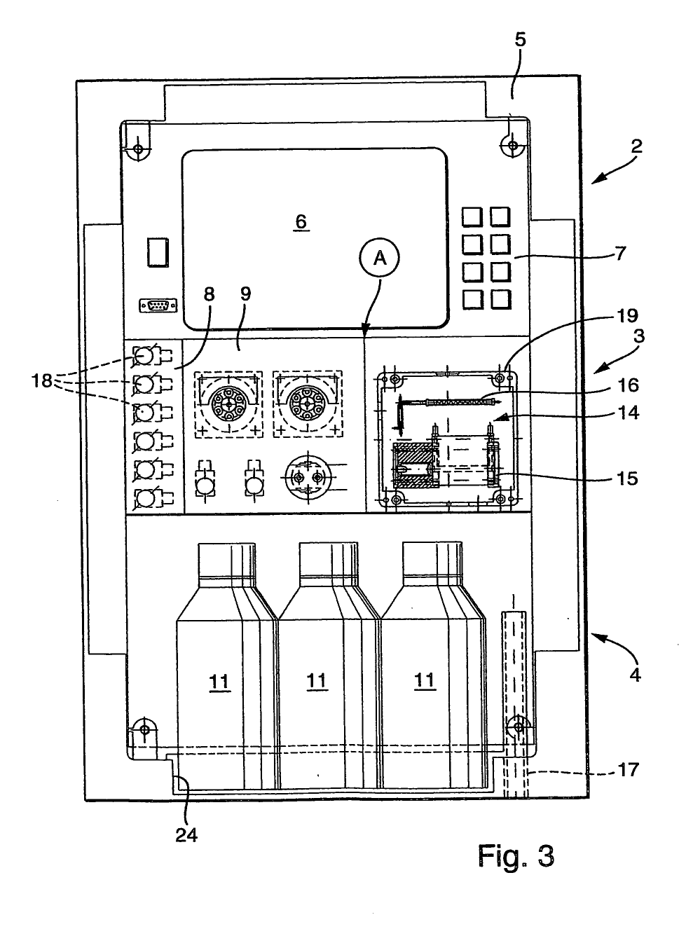

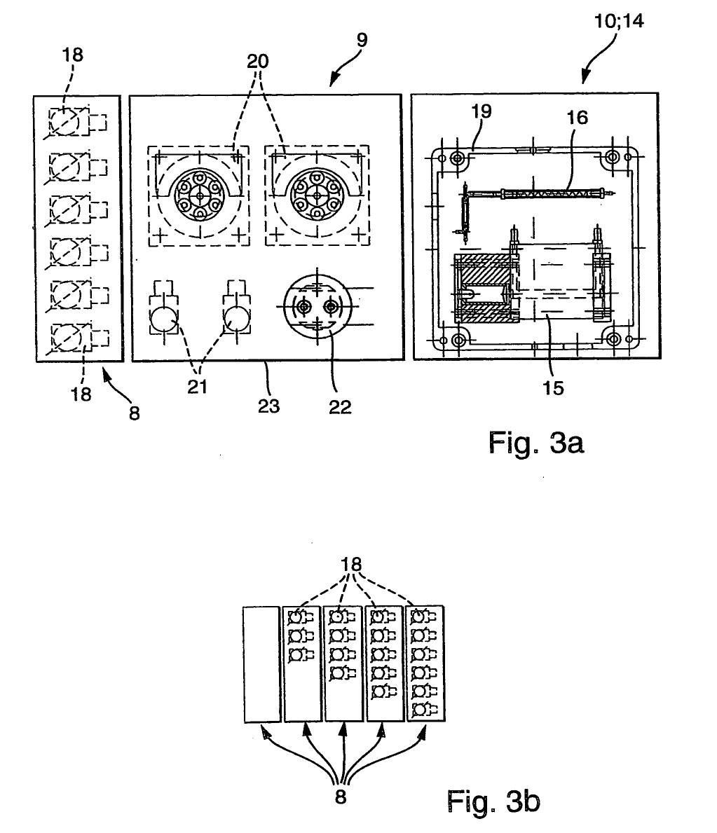

FIG. 3: a front view onto a form of embodiment of the analyzer of the invention suited for calorimetric measurements,

FIG. 3a: a presentation of the detail A of FIG. 3,

FIG. 3b: a presentation of various expansion stages of the duct switching module,

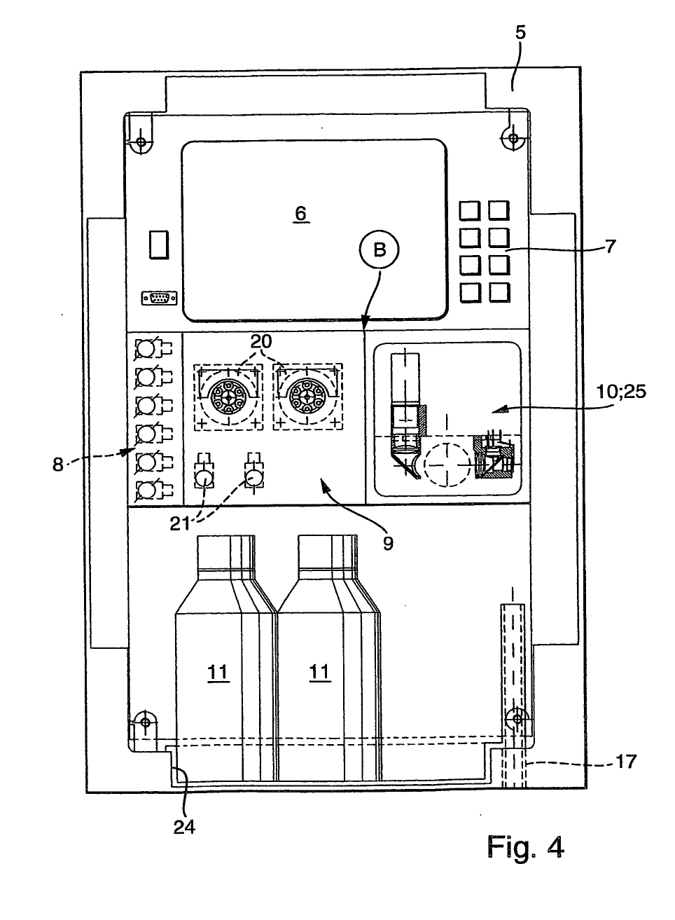

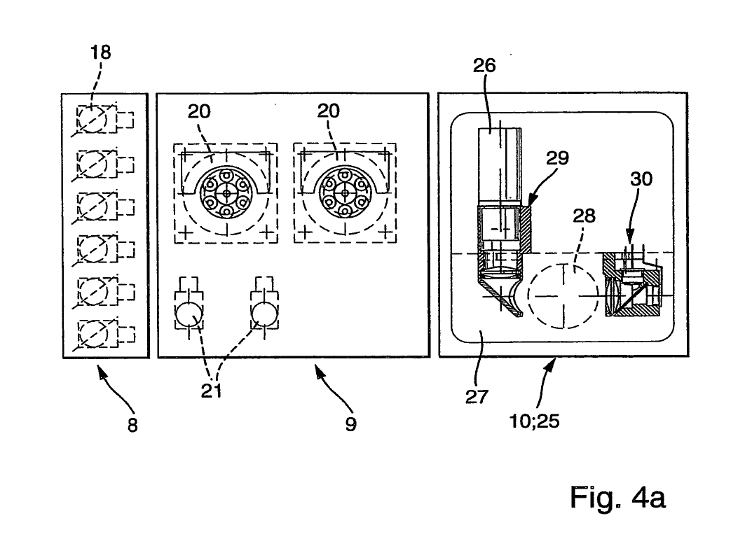

FIG. 4: a front view of a form of embodiment of the analyzer of the invention suited for photometric, or spectrometric, measurements,

FIG. 4a: a presentation of the detail B of FIG. 4,

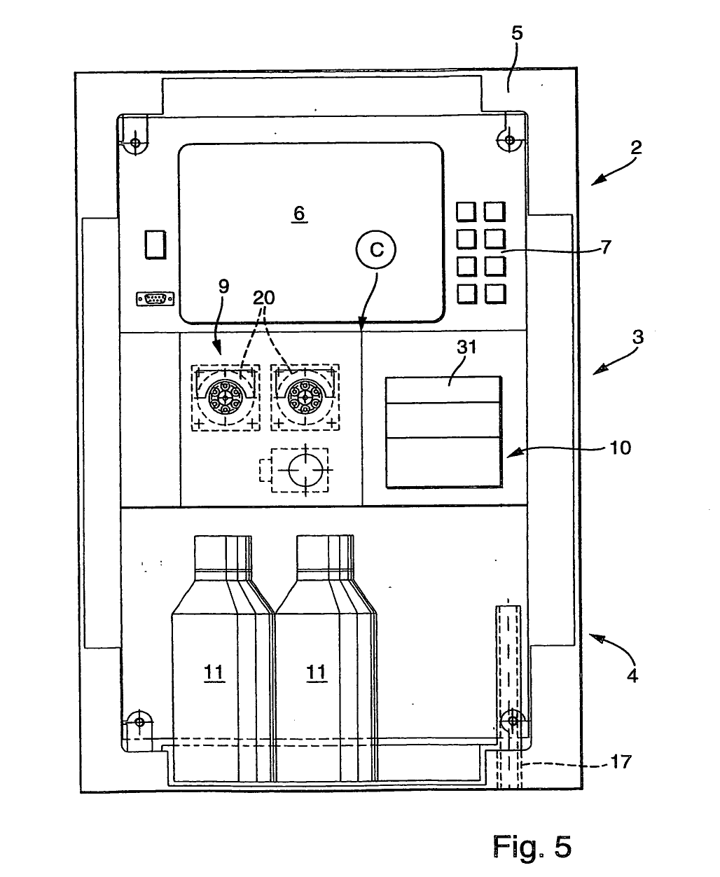

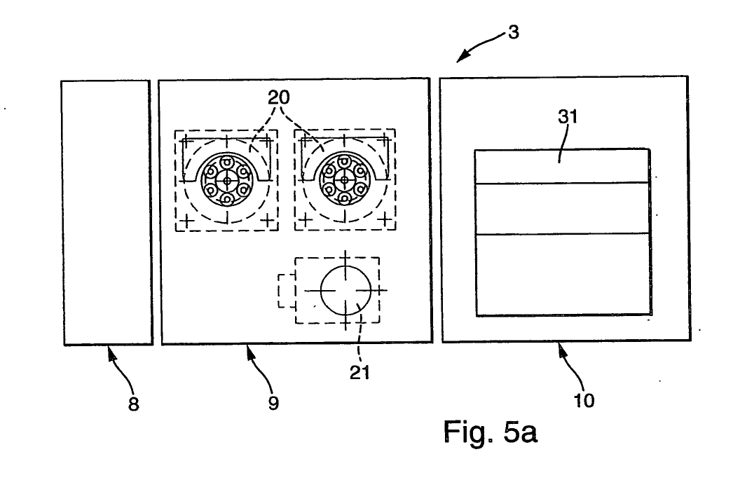

FIG. 5: a front view of a first form of embodiment of the analyzer of the invention suited for ion-selective measurements,

FIG. 5a: a presentation of the detail C of FIG. 5,

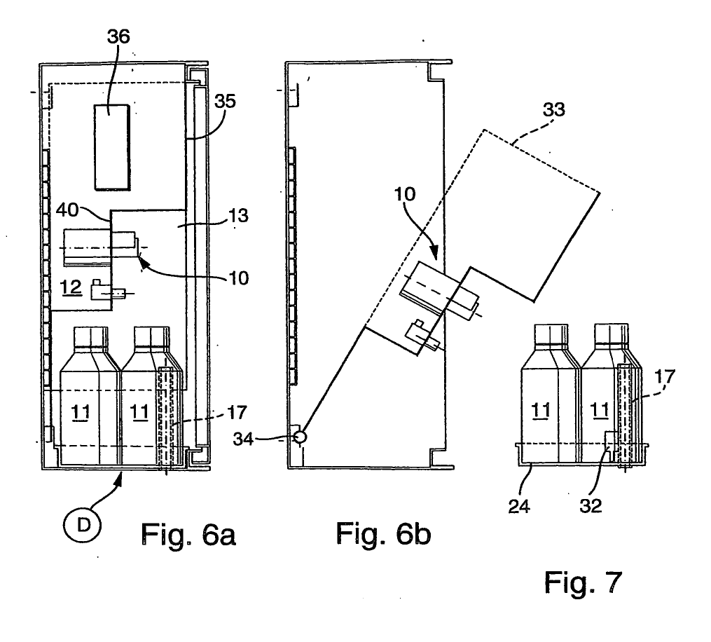

FIG. 6a: a side view of a foldable embodiment of the analyzer of the invention in the operating state,

FIG. 6b: a side view of the foldable embodiment of the analyzer of the invention shown in FIG. 6a in the opened state,

FIG. 7: a presentation of the detail D of FIG. 6a,

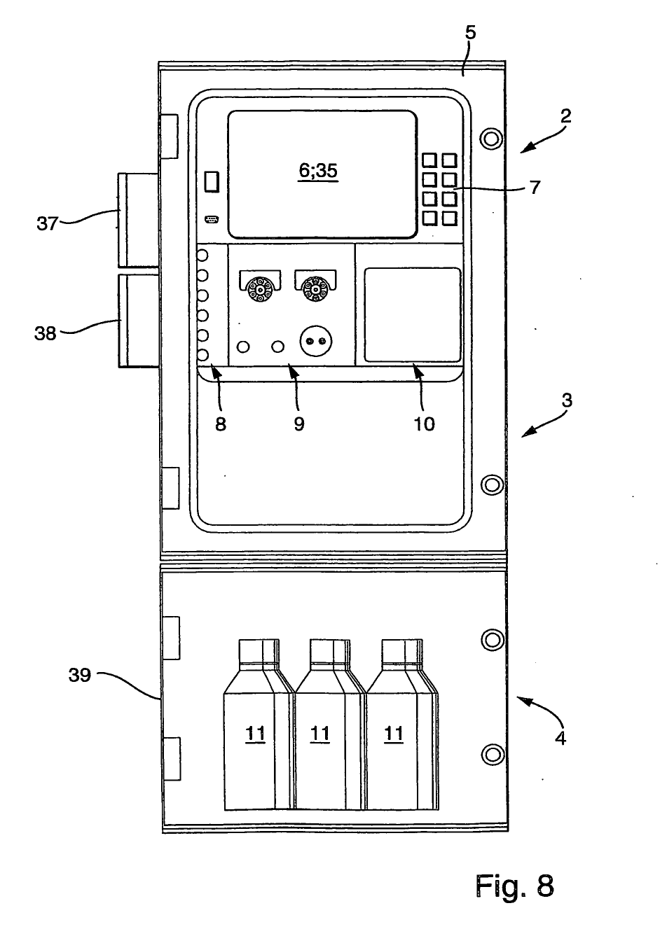

FIG. 8: a front view of a form of embodiment of the device of the invention with accessory modules, and

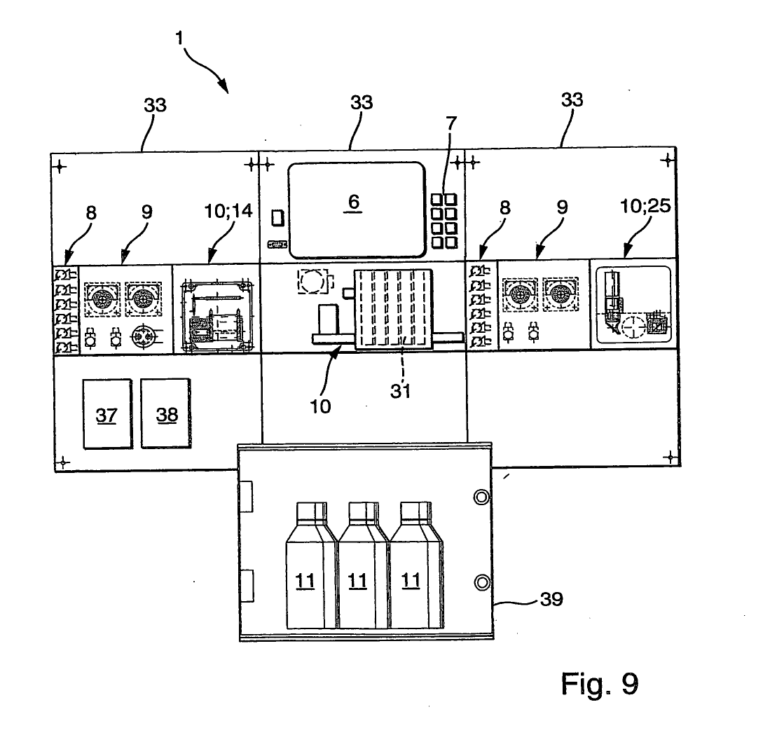

FIG. 9: a front view of a form of embodiment of the analyzer of the invention suited for multi-parameter analyses.

FIG. 1 shows a schematic presentation of the analyzer 1 of the invention in front view. FIG. 2 shows the analyzer 1 of FIG. 1 in cross section. In the case of the analyzer 1 of the invention, there is a clear division according to the following functional areas:
Functional area 2, containing the electronics and/or the display and/or operating module in the upper part of the housing 5;
functional area 3, containing the analysis modules, i.e. with at least one function module 10 and possibly a mixing module 16, a pump module 9 and, depending on the application, a duct switching module 8 in the middle part of the housing 5;
functional area 4, containing the reagent and cleaning agent storage in the lower part of the housing 5.

The division into separate functional areas 2, 3, 4 brings the following advantages:
a clear arrangement of the modules
simple installation
simple maintenance
simple service.

Furthermore, there is, as can be seen from FIG. 2, a clear division in the functional area 3 between the wet part 13 and the dry part 12. Electronic and electrical components are divided from the mechanical components of the analysis modules 8, 9, 10, 16 by a dividing wall 40. The functional area 2 is, incidentally, analogously embodied. FIGS. 6a and 6b are a good illustration of this embodiment, where the electrical/electronic components are, additionally, made easily accessible by the folding of the carrier unit 33 out of the device.

The essential components of the analyzer 1 of the invention are, as already explained above, the pump module 9, the function module 10 and the electronics module 36. Additionally, the presented analyzer 1 includes a display/input module 2, which contains a display 6 and an operating keypad 7.

The electronics/display and/or operating module 2 is arranged in the upper region of the housing 5. Spatially therebeneath, the so-called analysis modules are located; in the illustrated case, the analysis modules include, as already indicated, a duct switching module 8, a pump module 9 and a function module 10. Beneath the area 3 of the analysis modules is located the area 4 for reagent and cleaning agent storage. The reagents and cleaning agents are stored in receptacles 11. By the purposeful division into the functional areas 2, 3, 4 and the subdividing of the functional areas 2, 3, 4 into modules, one can see, already at first glance, that the analyzer 1 of the invention is orderly, reliable, and precise.

FIG. 3 shows a front view of a form of embodiment of the analyzer 1 of the invention suited for colorimetric measurements. FIG. 3a provides an enlarged presentation of detail A of FIG. 3. FIG. 3b contains a presentation of various expansion stages of the duct switching module 8.

To be noted in FIG. 3, as well as in FIGS. 4 and 5, is the essentially comprehensible, clear and well laid-out construction of the analyzer 1 of the invention. Each module has been assigned a fixed place within the housing 5, or on the carrier unit 33, as the case may be. Clearly, the detailed structure of a function module 10 will differ, depending on the particular application. Thus, in FIG. 3, a photometer module is installed as the function module 10. In FIG. 4, the function module 10 is a UV-spectrometer module 25, or a UV-photometer module, while FIG. 5 involves an ion-selective measurement module 31 for the function module 10. The modules 8, 9, 10, 16 of the functional area 3 of the analysis modules of FIGS. 3, 4 and 5 are displayed again in FIGS. 3a, 4a and 5a in more detail. The dimensions of the modules 8, 9, 10, 16 are chosen such that e.g. a photometer module 14 can be mounted, without problem and simply, in the housing 5, or on the carrier unit 33, as the case may be, instead of an ion-selective measurement module 31. The photometer module 14 shown in FIG. 3 includes a mixer module 16 and a photometer block 15. Of course, the mixer module 16 does not have to be an integral part of the photometer module 14. The mixer module 16 can also be arranged outside of the photometer module 14.

The pump module of FIGS. 3 and 3a includes two peristaltic, or flexible tube, pumps 20. Via the peristaltic pumps 20, the permeate, thus the collected measurement sample, and the reagent, are charged into the mixer module and subsequently into the function module—here, the photometer module 14. Indicated in FIGS. 3 and 3a are the tube pinch valves 21. The likewise illustrated dosing tube 22 is an optional feature. According to the invention, the structure of the pump module 9 is chosen depending on the particular application. Thus, in certain instances, one pump 20 can be sufficient; in other applications, more than two pumps 20 will be needed. In turn, the pump module 9 is embodied such that any combination can be realized, without anything changing as regards the essential modular construction and the module dimensions.

FIG. 3b illustrates different variations of the duct switching module 8. In the case of the left variant, absolutely nothing is switched. In the case of the other duct switching modules, the number of valves 18 depends on the maximum number of ducts to be operated. Preferably, the valves 18 are two-way valves. Control of the valves 18, the pumps 20 and the function module 10 occurs via the suitably adapted electronics module 36. This electronics module 36 is likewise so embodied that it can be matched to a particular application with little trouble.

As can also be seen in FIGS. 3, 4 and 5, the receptacles 11 are positioned in a collecting pan 24. This collecting pan 24 can also serve for transport of the receptacles. Reacted test samples and used cleaning agent are discharged via the outlet tube 17. As shown in FIG. 7, a leak sensor 32 is also provided in the collecting pan 24.

FIGS. 6a and 6b show in side view an analyzer 1 of the invention that can be folded out of the housing 5.

FIG. 8 is a front view of a form of embodiment of the analyzer 1 of the invention equipped with accessory modules 37, 38, 39. These accessory modules are an external sample collector 37, in which the test samples are stored, an external digestion module 38, and a refrigeration module 39.

FIG. 9 shows a front view of a form of embodiment of the analyzer 1 of the invention suited for multi-parameter analyses. In particular, this installation contains, as function modules 10, a photometer 14, an ion-selective measurement module 31 and a UV-spectrometer module 25. The different modules are actuated and evaluated by an electronics module 36. Similarly, only one display module 35; 6 and one operating module 7 are provided. The same is true for the reagent and cleaning agent storage. The separate modules 14; 25; 31; 8, 9 of the different analyzers are arranged on a carrier unit 33.

1-21. (canceled)

22. A device for the analysis of a test sample and for providing corresponding analysis data, the device having several functional areas including the following exchangeable modules:
at least one function module, which is embodied such that it provides measurement signals representing at least one physical or chemical process parameter;
at least one pump module, which is embodied such that it supplies into said function module in predeterminable cycles, depending on the particular function module being used, a predeterminable amount of: sample, and/or a predeterminable amount of at least one reagent, or a predeterminable amount of a cleaning agent; and
an electronics module, which controls the working cycles of said particular pump module being used and/or of said particular function module being used, which evaluates the measurement signals delivered by said function module and which provides the corresponding analysis data of the test sample.

23. The device as claimed in claim 22, wherein:
the function module comprises an ion-selective measuring device or a calorimetric measuring device.

24. The device as claimed in claim 23, wherein:
the colorimetric measuring device comprises a photometer or a spectrometer.

25. The device as claimed in claim 1, wherein:
a device for preparing the test sample is integrated into the function module.

26. The device as claimed in claim 23, wherein:
a mixing module is provided, in which the test sample and the at least one reagent are mixed together in a predeterminable ratio.

27. The device as claimed in claim 22, wherein:
a display module is provided, on which, among other things, the analysis data is illustrated.

28. The device as claimed in claim 27, wherein:
said electronics module is embodied such that it is usable for different display modules.

29. The device as claimed in claim 27, wherein:
at least one of the further following modules is provided:
a duct switching module for switching between different process cycles;
a measurement location switching module for extracting a test sample out of at least two different measurement locations;
a staging module, with which a quantity of sample is taken from the measurement location and in which the quantity of sample is stored before the analysis;
a refrigeration module for cooling the reagent and/or the test sample; and
a digestion module for sample preparation.

30. The device as claimed in claim 22, wherein:
said modules are exchangeably mounted on a carrier unit.

31. The device as claimed in claim 30, wherein:
said carrier unit is arranged in a housing.

32. The device as claimed in claim 30, wherein:
said carrier unit is mounted on a frame.

33. The device as claimed in claim 32, wherein:
said frame or said carrier unit is embodied such that it can be folded out.

34. The device as claimed in claim 22, wherein:
at least one receptacle is provided, in which the at least one reagent is stored.

35. The device as claimed in claim 34, wherein:
a collecting unit is provided, in which at least one receptacle for the reagent and/or cleaning agent is arranged; and
said collecting unit is constructed as a leakage guard and/or a transport container.

36. The device as claimed in claim 31, wherein:
said electronics module is arranged in the upper part of said housing or said carrier unit.

37. The device as claimed in claim 36, wherein:
the electrical/electronic components of the modules, or the dry part, are arranged divided from the mechanical components of the modules, or the wet part, by at least one dividing wall.

38. The device as claimed in claim 22, wherein:
an outlet is provided, via which a reacted test sample and/or a cleaning agent for the cleaning of said pump, function and mixer modules are/is discharged.

39. The device as claimed in claim 38, wherein:
said outlet is provided at a side wall of a housing; and
the reacted test sample and/or the cleaning agent are/is conducted to said outlet via a connection line.

40. The device as claimed in claim 38, wherein:
an outlet tube is provided, which is arranged in the lower part of housing.

41. The device as claimed in claim 40, wherein:
the cross sectional area of said outlet tube is plural-times greater than the cross sectional area of the outlet opening of said function module.

42. The device as claimed in claim 22, wherein:
a plurality of the modularly constructed measuring devices are arranged spatially neighboring one another; and
a common electronics module is provided, via which the individual measuring devices are actuated and which makes the analysis data of the individual measuring devices available.
